(19) United States
(12) Patent Application Publication
(10) Pub. No.: US 2026/0278223 A1
(43) Pub. Date: Sep. 17, 2026

(54) Physics-Based Design for Automatic Assembly

(71) Applicant: Bright Machines, Inc., San Francisco, CA (US)

(72) Inventors: Barrett Christopher Clark, Atlanta, GA (US); Emmanuel Gallo, Oakland, CA (US); Sashank Ganti, Urbandale, IA (US); Michael Kevin O'Brien, Albany, CA (US); Philip Dean Beffrey, Petaluma, CA (US); Murali Pappoppula, Fremont, CA (US); Dan Avigdor Zilberman, Ramat Hasharon (IL); Joshua Zorn, Belmont, CA (US); Ankita Nugyal, Pittsburgh, PA (US); Hari Ramachandran, Cumming, GA (US)

(73) Assignee: Bright Machines, Inc., San Francisco, CA (US)

(21) Appl. No.: 19/566,770

(22) Filed: Mar. 13, 2026

Related U.S. Application Data
(60) Provisional application No. 63/772,419, filed on Mar. 14, 2025.

(51) Int. Cl. G06F 30/27; G06F 119/02

(52) U.S. Cl. CPC G06F 30/27; G06F 2119/02

(57) ABSTRACT

A method of providing a design for automated assembly (DFAA) system comprising receiving a model of a component and a part for insertion into the component, identifying an assembly process for assembling the component and the part, and evaluating the component, the part, and the assembly process using a multi-phase evaluation including a geometric, a spatial, and a physics-based evaluation. The method further comprises outputting results of the calculations for assessment of the design for assembly. The assessment in some embodiments may include assessment for efficient assembly (manual & automated) and/or manufacturing at scale.

### RELATED APPLICATIONS

The present application claims priority to U.S. Provisional Application No. 63/772,419 field on Mar. 14, 2025, and incorporates that application in its entirety.

### FIELD

The present invention relates to product design, and more particularly to enabling incorporation of assembly considerations into the design process.

### BACKGROUND

Design engineers, who are primarily focused on product requirements, do not possess the skillset or the knowhow of the build, assembly, or automation processes. This lack of knowledge prevents them from ensuring that their designs meet the requirements of assembly until much later in the design cycle—typically after a few expensive prototypes are produced. Companies have addressed this gap using specially trained engineers who use their knowledge and experience to identify problems as early as possible. Even with a skilled workforce in place, most designs are not made for automatic assembly, because automated assembly is a constrained process that is highly sensitive to design variation. This causes cycles of redesign, which increases the time to market as well as the cost to design and introduce new products.

### BRIEF DESCRIPTION OF THE FIGURES

The present invention is illustrated by way of example, and not by way of limitation, in the figures of the accompanying drawings and in which like reference numerals refer to similar elements and in which:

FIG. 1 is a system diagram of one embodiment of the design for automated assembly (DFAA) system.

FIG. 2 is an overview flowchart of one embodiment of the DFAA process.

FIG. 3 is a flowchart of one embodiment of insertion tolerance and clearance analysis for the process.

FIG. 4 is a flowchart of one embodiment of the various types of validations which may be performed as part of the DFAA process.

FIG. 5 illustrates an exemplary set of capabilities that may be available in the DFAA system.

FIG. 6 illustrates a 3D view of the subsystems and parts that may be analyzed in an exemplary DFAA process.

FIGS. 7A-7B illustrates an exemplary determination of an insertion path and associated swept volume.

FIGS. 8A-8B illustrates an exemplary determination of an insertion path and associated swept volume.

FIG. 9 illustrates an exemplary support structure that may be used with the DIMM insertion process.

FIG. 10 illustrates one embodiment of a tolerance analysis for insertion.

FIG. 11 is a block diagram of a computer system that may be used with the present application.

### DETAILED DESCRIPTION

The present design for assembly (DFA) system provides an improved design and feedback process that combines digital mockup & design review functionality that goes above and beyond existing tools, with a specific emphasis on build, assembly, and automatability of the assembly process of end products. The system is designed to help design and manufacturing engineers collaborate using advanced techniques. By incorporating a wide range of data sources and simulation capabilities, the system enables companies to significantly reduce change and rework costs due to automation, assembly, and manufacturability issues. It also improves the potential for optimizing designs for robotic automation and integrates critical data which is not considered in present systems into the process.

In one embodiment, failure mode and effects analysis (FMEA) of component parts is taken into account during the design and engineering phases. In one embodiment, tolerances of components as well as automation equipment are considered. The present system provides one or more of: 3D visualization and analysis of product designs; design for excellence (DFx) and assembly; validation tests using physics-based simulation; digital twin simulation for evaluating automatability and design recommendations; AI-based classification, feature recognition and recommendation engine to capture and build on historical data; visual collaboration for communication between stakeholders; inspection based on CAD models; and integration with data management systems including design, engineering and production systems.

In some embodiments, the present system uses a multi-phase evaluation process including multiple types of evaluations, to ensure that the assembly—insertion of parts into the components—can be successfully completed using manual and/or automated assembly methods. The evaluations may include geometric, spatial, and physics-based evaluations. Geometric evaluations use the geometry of the component and parts to ensure that the spacing and assembly can function. In some embodiments, the geometric methods use the CAD model of the components and parts to evaluate the spacing. The spatial evaluations use the relationship of the parts to each other during the assembly process, to ensure that there is no conflict between the parts. The spatial method also takes into account the robotic arms/fingers/tools used during the assembly process. This ensures that for example there are no screws that must be tightened that cannot be reached, or components inserted into a position where there is not enough clearance. In some embodiments, this evaluation may be made using a swept volume evaluation. The physics-based evaluations look at the interaction of components with each other during installation. For example, if a component needs to be snapped into place, it evaluates the aspects associated with that. Physics-based methods also take into account operator fatigue based on the amount of weight of components which are manually placed by an operator, for example. The combination of evaluations together provides an assessment of the design for efficient assembly. The evaluations can also be used to ensure that the assembly can be manufactured at scale. The system enables an iterative evaluation, as the component, part, and/or assembly process are changed during the process.

The present application provides an example of the DFA system for assembling a computer server system. However, one of skill in the art would understand that the present system has applicability to any product which could be designed and optimized for an assembly process. This process improves design technologies by enabling the design process to take into account the assembly process, to ensure that the designed product can be assembled using available processes, which may include automated assembly—for example using robotics—and/or manual assembly. The process improves critical product design iterations by incorporating DFx checks (ex: available assembly processes, manual or robotic) iteratively into the process at design time rather than as a validation step after design is completed. This continuous improvement of design not only leads to significant shortening of the design to manufacturing lead time but also results in design choices that optimize for mass production. This provides a technical improvement to product design and assembly processes.

As an example of an existing process that would benefit from the improved processes described, currently servers and GPUs are primarily designed—at design time in product development—with human operators and manual assembly in mind. This makes automation of server assembly more difficult since specifications for robotic/automated assembly are not considered by design engineers. By not accounting for automated assembly, the process results in churn and adds complexity in automation and slows time to market. The DFA system design is useful for customers which can include OEMs, ODMs, CMs, Chip Designers, Cloud service providers and Suppliers—who would benefit from improvement of product design for assembly and automation, essentially enabling faster time to market by designing in accommodations for automated assembly at design time. The present system provides tools to validate CAD designs for assembly and manufacturability, assess degree of automatability of assembly process to improve designs, and assess optimizations for design choices based on these factors. Although the below examples are based on a server system, one of skill in the art would understand that the present system may be used for the assembly or manufacturing of any designed components.

The following detailed description of embodiments of the invention make reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized, and that logical, mechanical, electrical, functional, and other changes may be made without departing from the scope of the present invention. The following detailed description is, therefore, not to be taken in a limiting sense, and the scope of the present invention is defined only by the appended claims.

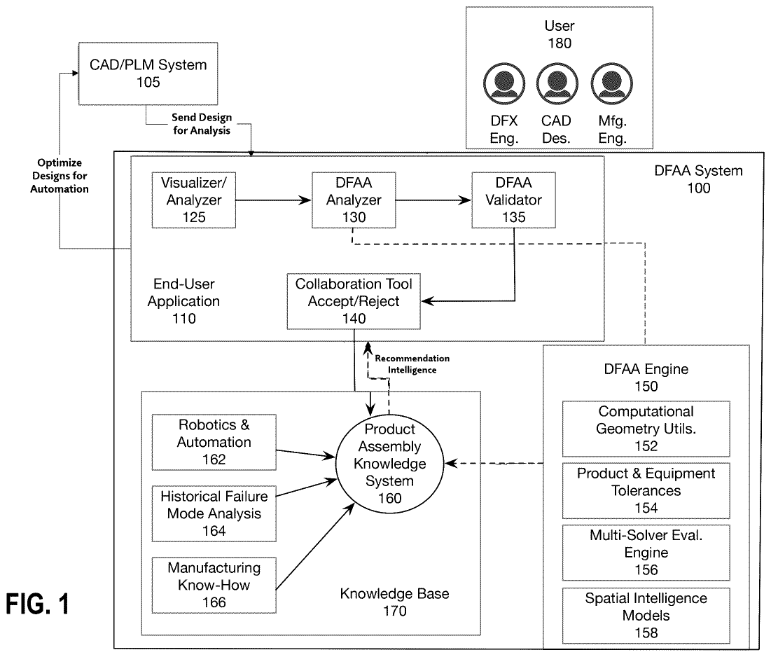

FIG. 1 is a system diagram of one embodiment of the design for automatic assembly (DFAA) system. In one embodiment, there are three main components to the system: the end user application 110, the DFAA engine 150, and the cloud/know-how platform 170.

The end user application 110 in one embodiment is a web application that allows a user 180 to upload computer aided design (CAD) and product lifecycle management (PLM) data from CAD/PLM system 105 to the DFAA system 100. In another embodiment, the application may be a non-web application, or the end user application may be a simple web interface into the DFAA system.

In one embodiment, the initial DFAA analysis is run within the end user application 110. In one embodiment, the analysis analyzes CAD data from multiple sources using a visualizer/analyzer 125. In one embodiment, this includes identifying the product that is being designed. In one embodiment, this includes identifying a component into which one or more parts are to be assembled, as well as the positioning of the parts on the component. In one embodiment, the DFAA engine 150 is used for this analysis. In the product, various groupings of the parts, and the different subsections of the part of the product are identified.

The CAD data is sent to the DFAA analyzer 130, in one embodiment. The DFAA analyzer 130 utilizes the DFAA engine 150 to run various analyses on the CAD data. The DFAA engine 150 may include computational and geometry utilities 152 to provide geometric evaluations, product and equipment tolerances 154, multi-solver evaluation engines 156, and spatial intelligence models 158. This data informs the DFAA engine's tools which may include a physics and spatial artificial intelligence system, in some embodiments.

The DFAA validator 135 performs validations based on the results of the analysis. The results of the analysis are sent back to the end user application via collaboration tool 140. In one embodiment, the results may include identification of which portions of the design are optimized for automation and/or assembly, or problems for automation and/or assembly, and potentially recommendations on how to improve the product design for automatic assembly, and/or to improve existing automation systems to better function for assembling the product. The suggestions may be accepted or rejected, using collaboration tool 140.

The user 180 can accept or reject the recommendations and can take actions to modify the CAD based on the feedback, through collaboration tool 140. Thus, the feedback can trigger a re-design of the component and/or parts or subparts. This type of design iteration is much faster than the traditional method of design evaluation, providing a significant technical benefit. If the recommendations are taken into account, the updated design may be created in CAD/PLM system 105 and send back to the DFAA system 100 for re-analysis. In one embodiment, this provides a cycle, which enables a faster iteration of the design for automated assembly. Thus, the system is designed to iterate through the DFAA analysis multiple times, in one embodiment.

The system in one embodiment further includes a platform to capture in the information that that the DFAA system learns over time and capture that into a knowledge base 170, which may include one or more knowledge graphs and/or AI structures, so that as the system is used, it builds DFAA specific knowledge. This data can then be used by the DFAA system 100 to make more intelligent recommendations or suggest specific design changes.

In one embodiment, AI models are built on top of the knowledge base 170. The knowledge base 170 may include robotics and automation data 162, historical failure mode analysis (FMA) data 164, and manufacturing know-how data 166, all used by the product assembly knowledge system 160. The product assembly knowledge system 160 may be an AI system, which uses the various data to provide information for the DFAA engine 150 and end-user application 110.

In one embodiment, the AI system is used for predictive analytics. The AI system may including a spatial and physics based machine learning system, as will be described below. In some embodiments, multiple AI systems may be used. For example, the system may use a first AI system that is a large language model (LLM) which parses questions and a scene graph. The questions may include questions about the parts and subparts, part counts, and other relevant information about the design for analysis. In some embodiments, the system generates the questions automatically to analyze the CAD information. A second AI system may be a spatial and physics based machine learning system, which may be physics-informed neural network (PINN). Alternative AI models may be used. For example, in some embodiments, a pretrained deep-learning model with scalable inference engines may be used.

The DFAA engine 150 in one embodiment includes a CAD importer which extracts data from CAD or other formatted data. It also puts all of the data into a single unified system. This is used to understand the bill of materials (BOM), the topology, and the process as a whole for making the product. In one embodiment, the CAD importer automatically classifies the CAD into different objects. In one embodiment, the data from the AI engine in knowledge base 170 is used for this classification.

In some embodiments, the AI system interprets the scene graph, optionally augmented with 3D information. The AI system can analyze the scene graph, extract features descriptors from the CAD, partition the scene, compute feature descriptors per chunk, and match descriptors to see if the chunk contains the mesh for the component. Additionally, while component labeling may not be consistent within the CAD, the AI system can identify components as identical based on an analysis of the 3D information and text. In some embodiments, if no scene graph is available, the AI system may utilize feature descriptors extracted from the query CAD, and the 3D scene can be partitioned to speed up the search. For each partition, or chunk, a feature descriptor will be extracted and matched to descriptors to see if the chunk contains the mesh for the component. Additionally, while component labeling may not be consistent within the CAD, the AI system can identify components as identical based on an analysis of the image and text.

For example, the AI system can count part instances (for example, screws) by analyzing the 3D model and parsing the scene graph. This information is then used to ensure that all screws can be inserted in the correct locations and tightened to the correct tolerances, and that no screws are missing. The AI system also can be used to determine the weight of the various parts/subparts, which can be used in the operator fatigue evaluation, discussed below. One of the benefits of the system is that it can import CAD files from different sources and different places, and then very quickly identify the product, component, parts, subparts, etc.

After analyzing the CAD, the system identifies those areas of the product assembly which can be automated. The system then applies the analysis for each of those areas.

The DFAA engine 150 analysis techniques to determine whether the product can be manufactured using an automatic assembly system. In one embodiment, a number of separate tests are run. For example, the system performs a simulated insertion of a part into a component, to determine whether there is sufficient clearance for such an insertion, using product and equipment tolerances 154. In one embodiment, the insertion path may include twisting or angling the part to be inserted to fit it into its position on the component.

In one embodiment, once a path is determined, a swept volume for that path is calculated. The swept volume is effectively tracing an envelope of the part as it is moving along the path, to identify the different elements that might interfere with the movement. The volume can also be used to make other design changes or optimize the path. The swept volume represents the 3D path of the component. It also accounts for angling and tilting, and the corresponding changes in the “zone” of movement. In some embodiments, the spatial intelligence models 158 perform this determination.

In one embodiment, the system accounts for the tolerances. A tolerance stack-up analysis, performed by product and equipment tolerances unit 154 in DFAA engine 150, provides a calculation of tolerances for each of the components, and how those tolerances affect the physical process of assembly. For example, for a power supply that will be placed in a power supply bay, there are multiple components that make up the power supply, but there are only a few mating surfaces which must match to the power supply bay. The system does a minimum/maximum tolerance analysis, in one embodiment, to validate the latching of a different set of components (e.g., connectors at the end) based on the tolerance of the mating surfaces involved in the assembly. In one embodiment, the tolerance analysis includes minimum tolerances, maximum tolerances, and the combination of tolerances. In one embodiment, the tolerance analysis also takes into account the assembly method and assembly tools. For example, it would take into account a clearance needed for the robotic arm/tool being used to ensure there is space for the tool. It is not just the product that the system is accounting for, but the product in the context of the process and the assembly procedure that's being utilized. In some embodiment, this also accounts for manual assembly, ensuring that there is proper spacing for user fingers and tools.

In one embodiment, the system also calculates a wobble volume. The technique simulates a degree of “wobble” as the component is inserted and engages with the alignment pins, or other mechanisms, designed to lock it in place. The wobble volume evaluation provides the ability to evaluate the effectiveness and functionality of the designed pins and attachment mechanisms. The wobble analysis can be used to identify and recommend changes—e.g., adjustments to height, radius or tolerance specifications for the part and/or the attachment mechanism. The method calculates and displays a “degree of wobble” along various stages of insertion. An additional benefit of this method is that it assists in evaluating assembly of “blind connections”—where the connection cannot be visually ascertained because the pin/socket connections cannot be seen. The wobble volume evaluation determines the impacts on connector mating based on degree of wobble allowed by the alignment system at the time of engagement.

In one embodiment, the analysis also includes physics engine and/or spatial and physics based machine learning based validation. The DFAA models the characteristics of the materials that are being used, to ensure that the systems will work with automatic assembly. This includes both components such as latches that engage, as well as the material of the boards or other products, and their predicted amount and pattern of deformation during automatic assembly. In one embodiment, the system can provide recommendations for material changes or support structures to address deformation or movement issues identified to enable automated assembly.

The system in one embodiment also includes flexible component simulation. Flexible component simulation is the analysis of the automated attachment of cables and wiring, and other components that are in varied positions and postures during insertion, pre-insertion, and post-insertion. In one embodiment, the system takes into account the potential interference caused by such flexible components, as well as potential issues with automated assembly. In one embodiment, the system may be able to provide recommendations on how to affix, tape, or otherwise handle such flexible components during insertion to minimize issues.

In one embodiment, the system may operate at various levels. At the first level, the system looks only at product or CAD assembly. At the second level, the system may look at the product and how that product is assembled, e.g., a combination of the product and the state of assembly at individual steps involved in the assembly process. At the third level, the system looks at the product, the process step and the procedure (manual or automatic) involved for assembly. This simulates the full assembly process, ensuring that the system can identify collisions or interference between parts, sub-parts as well as equipment (manual or robotic) involved. In one embodiment, the third level utilizes a digital twin, to fully simulate an assembly process. For example, in assembly a motherboard with a number of heatsinks, the digital twin full assembly simulation would detect if there were no space for the tool to attach a last inserted heat sink due to the other heatsinks previously inserted. In some embodiments, the process may simulate a fully or partially manual assembly process. In evaluating the manual assembly process, the process may evaluate spacing (ex: finger clearance), operator fatigue (combined mass of assembled components to be installed) and features that reduce manual assembly errors (ex: inadvertent reverse mounting, keying etc.). Other aspects of assembly may also be evaluated for both automated and manual assembly, as well as assembly which incorporates both manual and automated portions. In some embodiments, the system may evaluate the entire assembly process and recommend aspects for automated versus manual assembly.

The output of the DFAA engine is an issues list, which provides the result of the layers of analysis. In one embodiment, the issues list may include reports, visual indicators showing issues, flagged problems or items that may be improved, etc. These results are provided to the end user application, as well as to the AI system within knowledge base 170, in one embodiment. In one embodiment, the system may include visual simulation results, such as simulation performed by the digital twin system. This provides easily understood feedback, showing changes that would be helpful to make the system ready for automatic assembly.

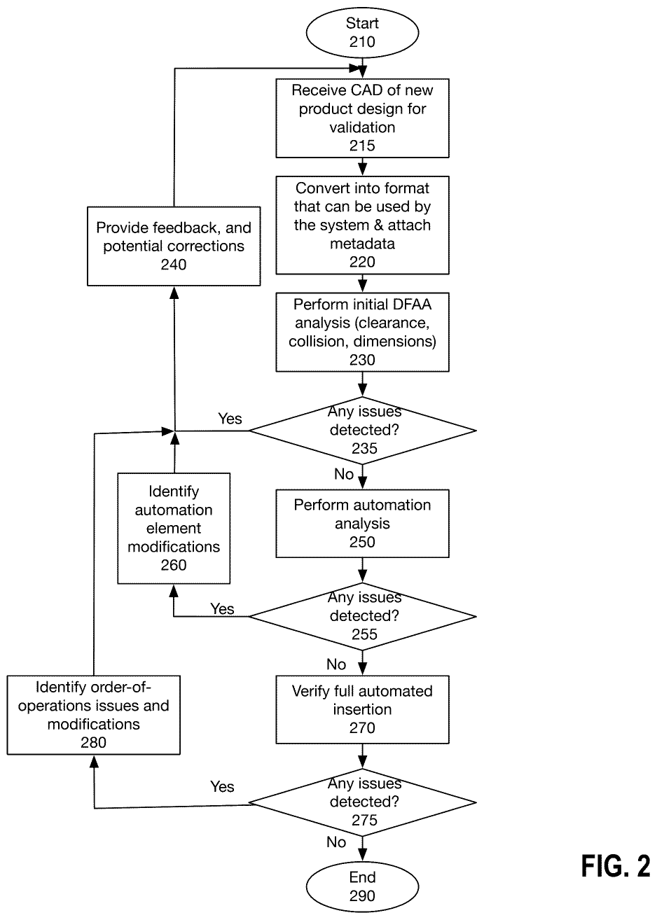

FIG. 2 is an overview flowchart of one embodiment of the DFAA process. The process starts at block 210. At block 215, the CAD or other design documents for the product are received. At block 220, the documents are converted into a format that can be used by the system and analyzed. In one embodiment, the CAD data is converted into a common format. This produces a mesh configuration, which can be used in a physics based analysis. In one embodiment a wrapper is used around the common format scene which allows the use of a class that combines meshes of various elements into a combined mesh, which reflects the real-world configuration of CAD components which are made of multiple child components. It also permits a parent component affecting the child component, in terms of scaling, rotation, and positioning.

The system then analyzes the information in the CAD, and identifies the subparts of the product, and associated characteristics, including locations for the part. In one embodiment, that information is attached to the converted CAD data as metadata.

At block 230, the initial DFAA analysis is performed. In one embodiment, the analysis includes identifying an insertion path for parts into the component, and doing a clearance, collision, and dimension analysis.

At block 235, the process determines whether any issues were found. If so, at block 240 feedback is provided. In one embodiment, potential corrections to address the identified are also provided. If no issues are detected, the process continues to block 250.

At block 250, automation analysis is performed. Automation analysis determines whether an automated assembly system can perform the steps necessary for the assembly. In one embodiment, the product may not be fully automatically assembled. Any steps that should be assembled manually may be identified in this process. In some embodiments, the system may also evaluate the manual assembly process to identify issues.

At block 255, the process determines whether any issues were found. If so, at block 260 potential automation element modifications are identified. The process then returns to block 240, where feedback is provided, and potential corrections adjustments are suggested. If no issues are detected, the process continues to block 270.

At block 270, the full automated assembly is verified, in one embodiment. The full automated assembly may not include a complete assembly with no manual assembly steps, but the full assembly process, which may include automated assembly and manual assembly processes. In one embodiment, this includes the insertion and attachment of each part into the component to complete the product. In one embodiment, the full assembly be verified by simulation using a digital twin type visual simulation software. The automated assembly verification in one embodiment tests whether there are sufficient clearance, sufficient support and stabilization, and sufficient capability in the assembly system to take each of the steps for assembly. The clearance evaluation adds the other components, as well as closing of any latches, handling of flexible components, etc. The stabilization evaluation ensures that when parts are inserted, the deformation of components is within specification, and will not damage the components or the parts, or keep the assembly from being able to be completed. The capability determines whether any assembly steps would require manual assembly or steps that the automated system cannot perform.

At block 275, the process determines whether any issues were found. If so, at block 280 any order-of-operations issues are identified, and modifications are suggested. Other issues are also identified, and the process continues to block 240, where feedback is provided. In one embodiment, potential corrections to address the issues identified are also provided. If no issues are detected, the process ends at block 290. Although this process is shown sequentially in one embodiment one or more of these types of tests and analysis may be performed in parallel. Furthermore, while these steps are described as separate processes there may be a combination process that provides more of these types of tests.

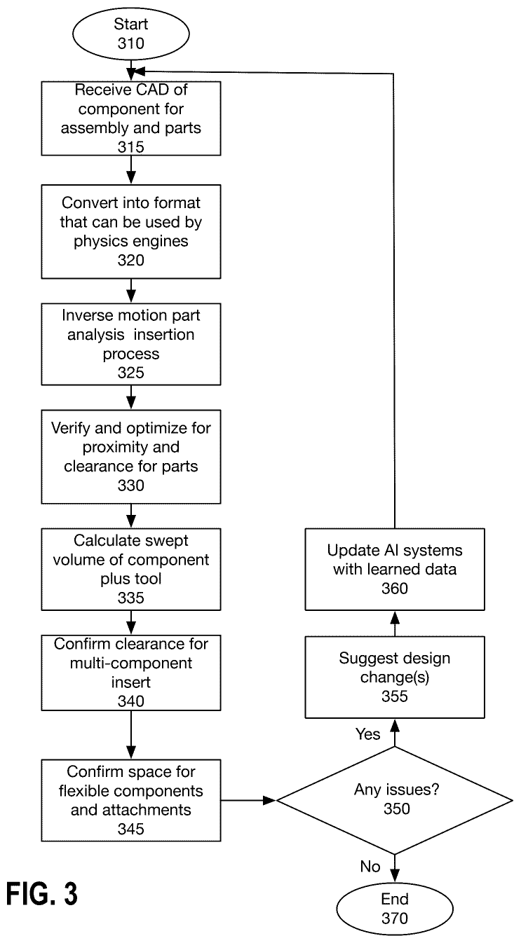

FIG. 3 is a flowchart of one embodiment of insertion tolerance and clearance analysis for the process. The process starts at block 310. At block 315, the CAD of the product, including a component and one or more parts for assembly are received.

At block 320, the data is converted into a unified format that can be used by the physics engines. In one embodiment, a standard format is used.

At block 325, an insertion path is determined for each of the components for assembly. In some embodiments, an inverse motion part analysis is used for determining the insertion path. The inverse motion analysis utilizes a reverse path (from final position to starting position) to identify the path that a component takes.

At block 330, the path is verified and optimized for proximity and clearance for parts. In one embodiment, the goal is to have a path that has the shortest distance, as long as it has sufficient clearance from all sides. In one embodiment, the “cost” is calculated based on path length. In one embodiment, three abstractions are implemented: clearance validity, clearance cost, and distance from origin. In one implementation, for the Clearance Validity Checker the system searches for a valid state which has a minimum distance from its surrounding which is greater than 0. The Clearance State Cost identifies for each state, the cost, which may be set to be the 1/min_distance. This means that when the cost is minimized, the distance is maximized. The Distance From Origin Goal sets a state as goal if it reaches a certain distance from the origin—the final insertion pose. This means that the algorithm will search in all direction until a path is found which satisﬁes this distance requirement. Alternate methods of identifying a shortest path with sufficient clearance may be used.

At block 335, the swept volume of the component plus tool is calculated. The swept volume presents the path clearance for a moving component, showing visually the clearance around the part as it is moved through the insertion path.

At block 340, the clearances are confirmed for a multi-part insertion. The insertion of each individual part may work, but there may be interference between different components being inserted, in series. For example, a DIMM being inserted not only has to clear the chassis into which it is placed, but also the previously inserted DIMMS, as well as other parts, which may be in close proximity. In some embodiments, altering the order in which components are inserted can remove such multi-part insertion issues.

At block 345, the space and positioning of flexible components and attachments is confirmed. Flexible components include wires and plugs and other components that are not in a fixed position when a part is picked up. Some flexible components also need to be handled, such as connectors at the end of cables. The validation in one embodiment ensures that the flexible components can be managed, and there is enough clearance for such components. In some embodiments, the system may include determining how to affix such flexible components during the insertion to ensure that they do not impact the insertion process and do not conflict with other components.

At block 350 the process determines whether there were any issues identified. If so, appropriate design changes are suggested to the component or parts or order of operations, at block 355. At block 360, the data learned from this process is added to the knowledge base, which is used to train the AI modeling system. The process then returns to block 315, to await the updated design. If no issues are identified, the process ends at block 370.

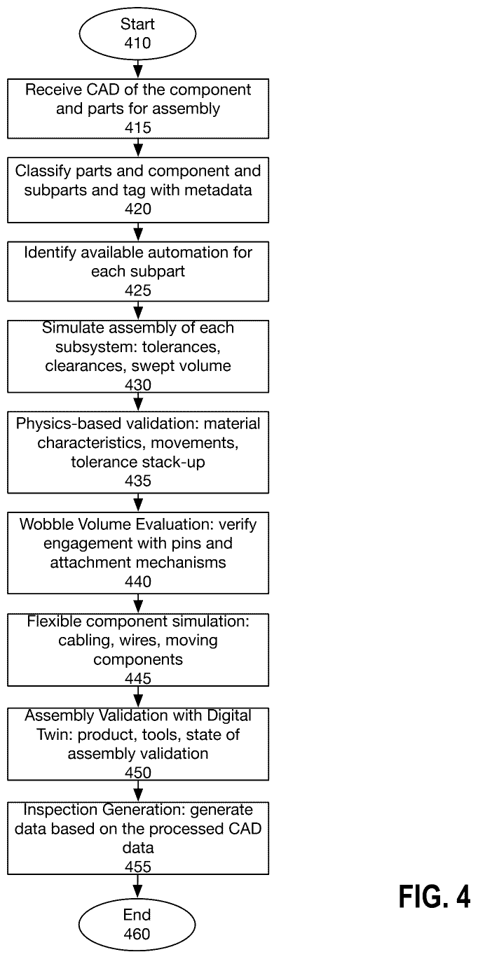

FIG. 4 is a flowchart of one embodiment of the various types of validations which may be performed as part of the DFAA process. The process starts at block 410. At block 415, the CAD or other formatted files for the product are received.

At block 420, the component, parts, and subparts are classified automatically, and tagged with metadata. The metadata in one embodiment defines the product, including product dimensions and other aspects of the product.

At block 425, the available automations for each subpart or component are defined. In one embodiment, the automations are known routines for component assemblies. For example, for assembling a motherboard, the system may have known automations for inserting memory modules, GPUs, CPUs, heat sinks, and power supplies, etc. Once the components/parts are identified, the system determines what can be automated. In one embodiment, if there are one or more steps in building the part that cannot be automated, the user is informed of this limitation. In some embodiments, the automated assembly process may be combined with one or more manual steps for handling those aspects of assembly that cannot be automated.

At block 430, the assembly of each subsystem is simulated to calculate clearances, swept volume, and tolerances. In one embodiment, tolerances are stacked to ensure that a minimum tolerance of one component combined with a maximum tolerance of another would not cause a collision.

At block 435, physics-based validation is applied, including evaluation of material characteristics, movements, and tolerance stack-up. The material characteristics address deformation, and the impact of movement on the fitting of components and parts. For example, when a DIMM is inserted into a motherboard, the printed circuit board deforms due to the insertion pressure. The physics-based validation ensures that the deformation is not above a threshold that might damage the motherboard or other components. In one embodiment, the deformation may be addressed by designing a support structure for the component, altering the sequence, etc.

At block 440, a wobble volume evaluation is performed. This evaluation simulates a degree of “wobble” as a part is inserted and engages with the alignment pins, or other mechanisms, designed to lock it in place. The wobble volume evaluation provides the ability to evaluate the effectiveness and functionality of the designed pins and attachment mechanisms. The wobble volume evaluation can be used to identify and recommend changes (e.g., adjustments to height, radius or tolerance specifications). In one embodiment, it calculates and displays a “degree of wobble” at various stages of the insertion path.

At block 445, physics based flexible component simulation is performed, which includes cabling, wires, and other moving components. In one embodiment, the flexible component simulation ensures that flexible components do not interfere with the assembly. This may include ensuring that the flexible components are stabilized, using a gripper that keeps the flexible components from being able to interfere, or using another mechanism to ensure that the flexible component does not cause a failure.

At block 450, assembly validation is performed with digital twin. In one embodiment, this includes a full simulation at third level, including accounting for product, tools, state of assembly, and ensures that the complete process can be successfully performed for all parts and subparts.

At block 455, the process performs inspection based on the translated CAD data and the analysis performed by the DFAA system. In one embodiment, the DFAA process also provides an inspection data set, to enable inspection based on the CAD model. In one embodiment, the system may use photo-realistic rendering of the product to generate inspection data sets for deployment. The process then ends at block 460.

In one embodiment, the system includes three phases. The first phase is the CAD import and visualization process. In one embodiment, this is performed in the web interface. The CAD data in one embodiment is native CAD data that is imported to a common format prior to the analysis process. The CAD data in one embodiment is interpreted in part based on a provided engineering bill of materials (EBOM). The data is used for 3D visualization of the product. In one embodiment, the system automatically provides classification, measurements, and metadata mark-up for the translated CAD data, to make it useful in the DFAA system.

The second stage is the clearance and dimensions evaluation within the DFAA system. In one embodiment, the system automatically generates extraction and insertion paths based on the product model data. In one embodiment, the paths incorporate end-of-arm tool (EOAT) CAD integration, to ensure that the calculated paths provide enough clearance for the tools as well. In one embodiment, the system also provides a display of the results of the simulations. This may include path animation, minimum distance clearance lines, and swept volume displays to visually indicate the path and its impact on the assembly.

The final stage is reporting back the results of the DFAA system's evaluation. In one embodiment, the reports include documentation of the minimum clearance along the insertion and/or extraction paths, as well as 3D project data, with markups, and optionally recommendations. In one embodiment, the recommendations may include changes to the configuration of the product to optimize the assembly. In one embodiment, the recommendation may include changes to the tooling, to support structures, or other aspects of the automation. This is an iterative process, in one embodiment, and the feedback is used to adjust the components, assembly process, or automation tools for optimalization. In one embodiment, the updated design is then evaluated again, until the system provides no further optimization suggestions.

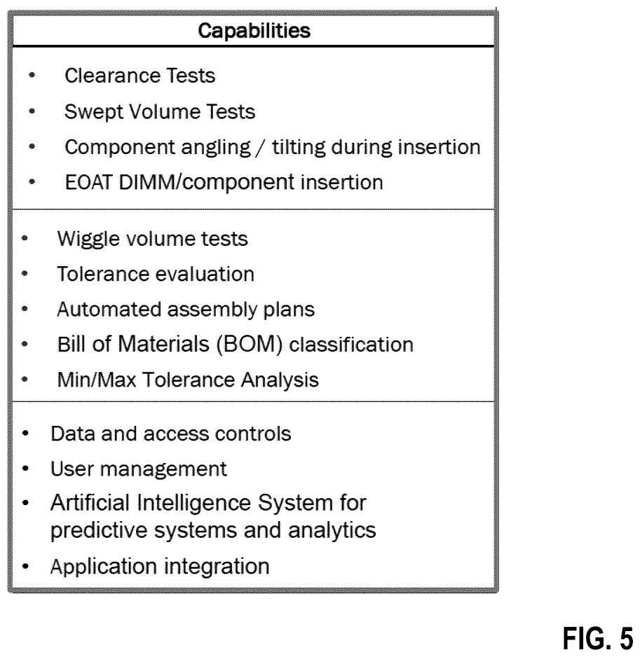

FIG. 5 illustrates an exemplary set of capabilities that may be available in the DFAA system. These capabilities may include clearance tests and swept volume tests, as discussed above. The capabilities may also include component angling/tilting during insertion, and EOAT DIMM/component insertion. The angling/tilting enables the insertion of a component into a tight space.

The capabilities may also include wiggle volume tests, or wobble evaluation, which evaluate if designed alignment features are effective in ensuring proper insertion of component systems, enabling blind insertion of components into parts that cannot be seen. The technique simulates a degree of “wobble” as the component to be inserted engages with the alignment pins designed to lock it in place. This would provide the analyst the ability to evaluate the effectiveness of the designed pins and recommend changes (e.g., adjustments to height, radius or tolerance specifications). The method in one embodiment calculates and displays a “degree of wobble” at each of the various stages of insertion.

The capabilities may also include tolerance evaluation, and minimum/maximum tolerance analysis as discussed above.

In one embodiment, the CAD device classification utilizes a combination of one or more of the image data, photographs of physical parts, synthetic data generated from renderings of CAD data, with a bill of materials provided, to ensure that all parts of the product are correctly classified and associated correctly with each other. The automated assembly plans utilize the calculated insertion/extraction data and tolerance data to validate the process for assembling the product. In one embodiment, the automated assembly plans may not include all steps of the assembly, if some steps cannot be automated given available techniques and tools.

In one embodiment, the system also provides data and access controls, user management, application integration. In one embodiment, the feedback provided by the system includes visual data which can be used for collaboration and communication between stakeholders. In one embodiment, the end user may be presented with the ability to provide and receive Measurements, Markup & commenting, Cross sectioning, and 3D capture & playback.

In one embodiment, the DFAA system can be integrated with existing design systems and customer product data management (PDM) systems. In one embodiment, as discussed above, the system also includes an artificial intelligence system for predictive systems and analysis, which can be trained based on the outcome of the iterative design process. This supports an AI-based classification, feature recognition, and recommendation engine to capture and build on historical data. In one embodiment, the AI system is used for the product classification, analytics, and recommendations for improving the product design for automatic assembly.

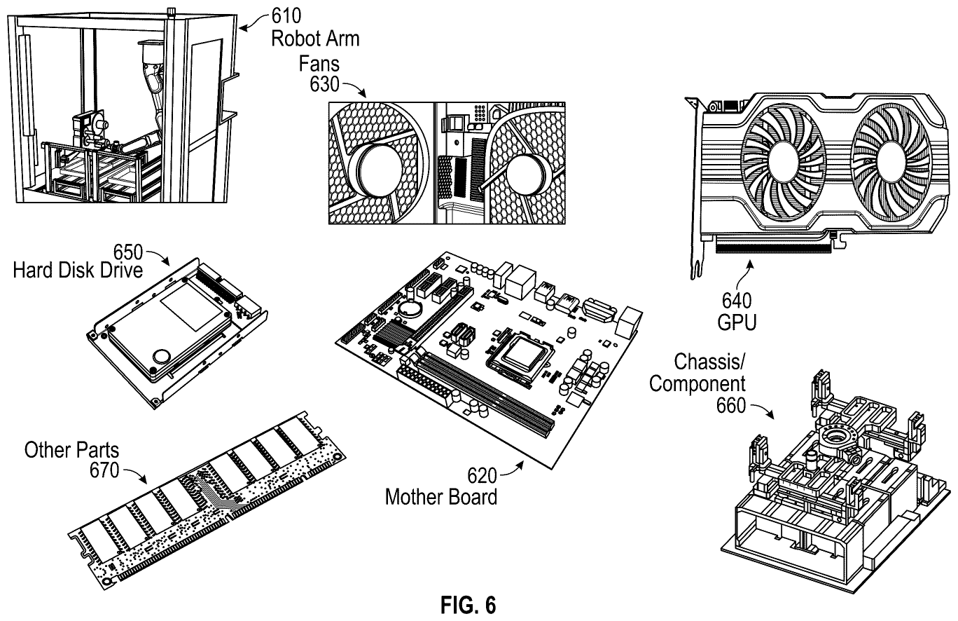

FIG. 6 illustrates a 3D view of the subsystems and parts that may be analyzed in an exemplary DFAA process. In one embodiment, this is the set of parts that are received from the user for assembly, and the robotic system 610 which provides the automated assembly features. This provides an exemplary image of the overall 3D environment, including the robot arm 610 with an end of arm tool, which performs the assembly of a motherboard 620. The other components illustrated include fans 630, graphics processing unit GPU 640, hard disk drive 650, chassis/component 660, and other parts 670. These components are assembled together by robotic system 610 which may include one or more robotic cells, with one or more robotic arms, performing insertion and fastening actions. Of course, the assembly of a motherboard is merely exemplary, and one of skill in the art would understand that the assembly process described can be applied to any assembly process which includes parts being fastened or coupled to each other, that can be at least partially automated.

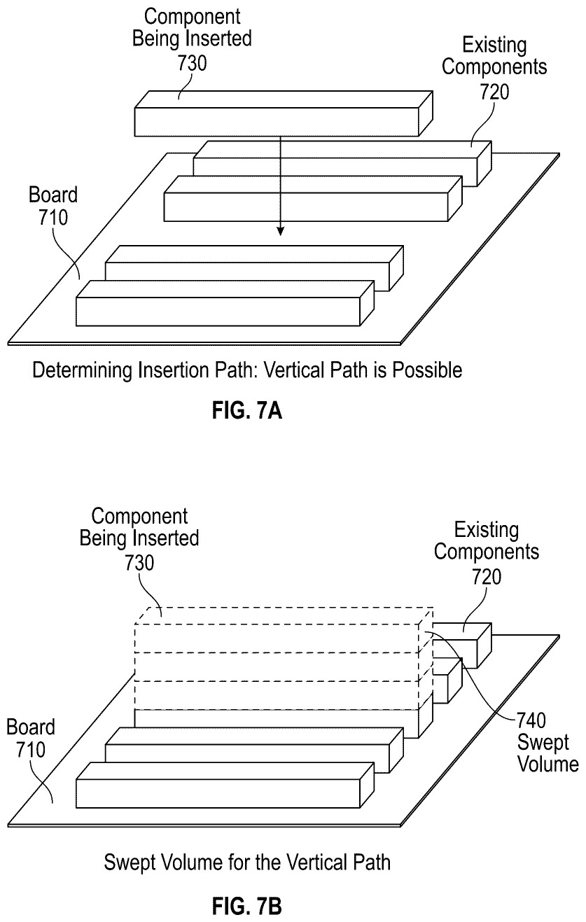

FIGS. 7A-7B illustrate a simplified determinations of an insertion path and associated swept volume. FIG. 7A illustrates an exemplary insertion path, showing the ability to insert a component 730 vertically onto board 710, with other components 720 already on the board 710. FIG. 7B illustrates the swept volume 740 for that vertical path. In one embodiment, the approach used for DFAA analysis is based on simulating a “path” for automated part installation. Once the method determines that such a path exists, it calculates discrete way points along the path to simulate motion along it. In one embodiment, the path is started from the inserted position and moves backward. The system then calculates clearance values of the nearest found objects as the installed part traverses this path.

The premise of this approach is that simulating the automation path enables the end user to study feasibility using CAD design data. The feedback from minimum distance can be applied to validate and/or propose changes to modify the design to account for automation path traversal. In one embodiment, the approach also extends the method to include End Of Arm Tools to further account for additional interferences between the tool and other parts of the assembly during the process. Availability of this knowledge further enhances the DFX engineer's ability to predict and improve the degree of automatability for these components. The advantage of incorporating EOATs is the flexibility to evaluate the cost-benefit of making changes to either the design or the automation equipment. The system evaluates steps in light of the “State of Assembly,” which represents the sequence of operations and the level of assembly completeness at any stage where automation is applied. Since this information is not derived from the CAD design, assumptions are made to estimate an isolated or likely state of assembly.

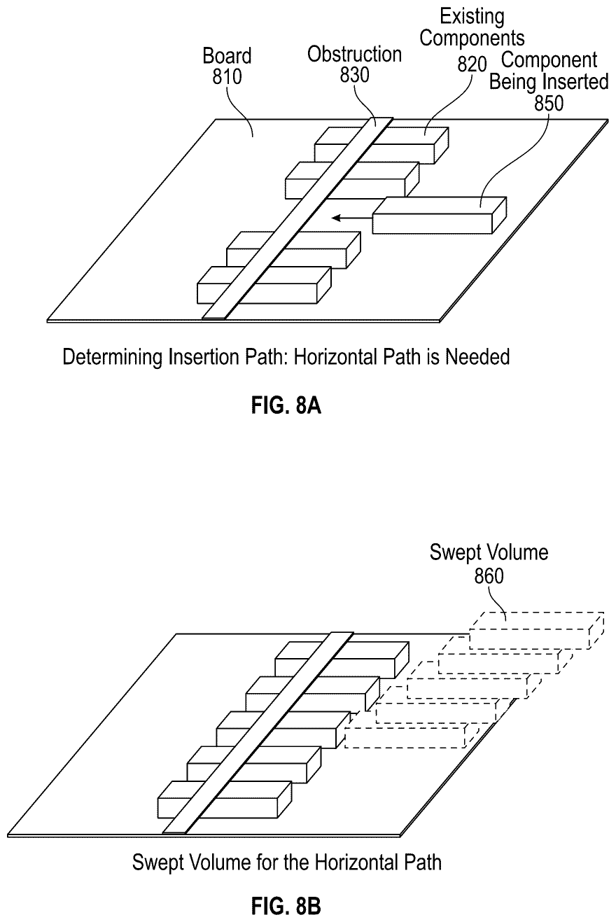

FIG. 8A illustrates an insertion path which is determined to be horizontal, because the vertical path is blocked by a cross-piece. In this example, the component being inserted 850 into a board 810 with existing components 820 is blocked by obstruction 830. Although in this simplified figure, the obstruction is a crossbar, in real configurations, there may be various obstructions, and the obstruction may have more complex shapes characteristics. FIG. 8B illustrates the swept volume 860 for the horizontal path for the component being inserted 850. With this configuration, the system determined that a vertical insertion path is not possible due to obstruction 830. It then evaluated other paths around the object and found a horizontal path that would allow for sliding the component being inserted 850 into place bar. A swept volume was generated to show the path.

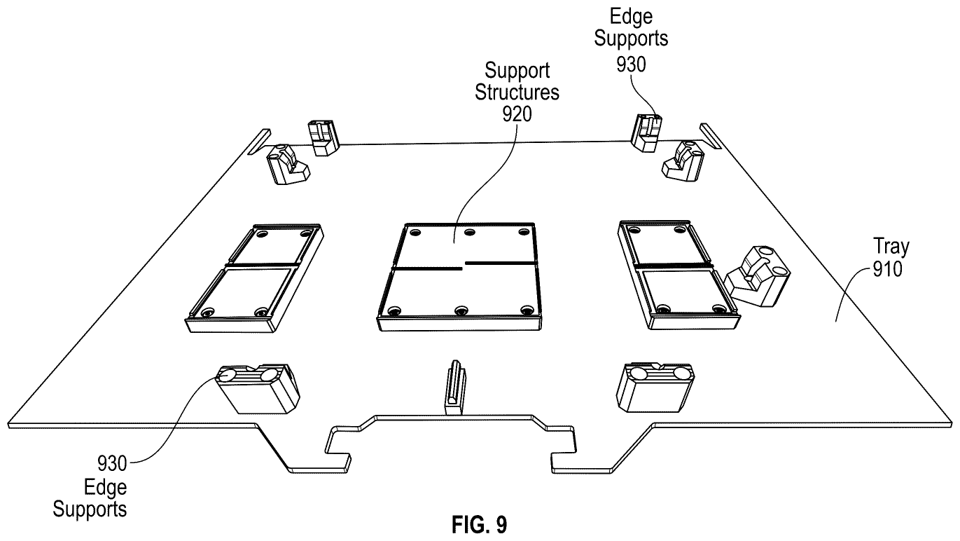

In one embodiment, physics based testing includes evaluating the strain on components during insertion. For example, for a motherboard onto which DIMMs are inserted, the strain on the motherboard in the tray during staging and during the insertion of the DIMMs is evaluated. FIG. 9 illustrates an exemplary tray, or support structure, underneath the motherboard that may be used with the DIMM insertion process. In one embodiment, a virtual model of the tray 910 and motherboard are used to assess the strain using a physics engine and/or a spatial and physics based machine learning system. In one embodiment, physical testing with a number of strain gauges may be used to obtain baseline data, which is subsequently used by the physics engine. In one embodiment, result of the assessment helps identify areas that need additional support when designing the tray 910 and ensures that the motherboard configuration enables the use of such support structures 920, 930. This approach significantly reduces time and effort, enhances accuracy, and provides clearer insights into where support is necessary, ultimately improving decision-making and operational efficiency. In one embodiment, the present system can determine that under some circumstances the strain is too high, potentially causing damage to the motherboard, or other components on the motherboard. In that case, the system evaluates the possible compensations that may be applied, including the use of support structures on the tray which supports the motherboard.

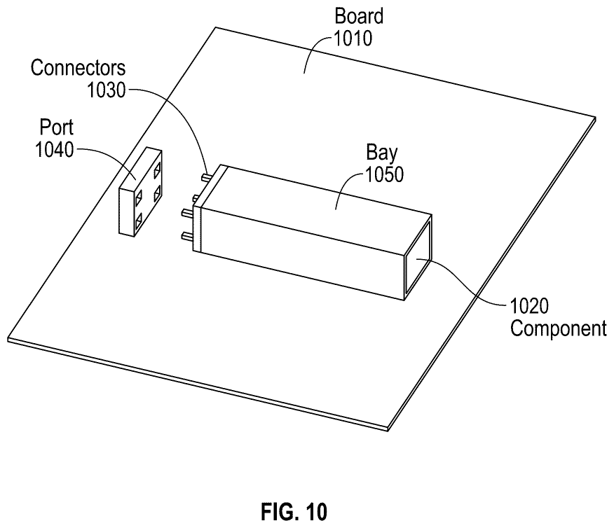

FIG. 10 illustrates one embodiment of a tolerance analysis for insertion. This example illustrates a product or component 1020 that includes a power supply bay 1050 inserted on a board 1010. Per the installation instructions, the goal is to prevent tilting during the insertion process to ensure proper latching of the connectors 1030 into the port 1040 at the end of the insertion. The goal of the system is to calculate an insertion path to help evaluate the impact of tolerance stack ups during installation procedure, given the state of assembly and the target power supply.

In this case, the installation process involves sliding a power supply component 1020 into a cage where the surfaces are expected to be touching. The goal of the DFAA system is to validate effective assembly within the accepted design constraints (e.g., tolerances). The clearance engine calculates an extraction path along the horizontal axis. An insertion motion was simulated along the extracted path that mimics a robot arm attachment (not shown) pushing the PSU into the cage. Note that collision is expected throughout the insertion path as the PSU is intended to slide along the walls of the cage. In one embodiment, the system can calculate a tolerance analysis using the simulated insertion path. The system can generate a report of observed clearances at various steps along the insertion path using a combination of {Min, Max} tolerance between the cage and enclosing box. A cross section tool can be used to evaluate the degree of engagement along the path. However, the minimum distance is adjusted based on the intended insertion. The system can also evaluate and report the degree of wobble at various stages of insertion. This provides additional feedback for successful installations based on allowed tolerances in the design and part specifications from suppliers.

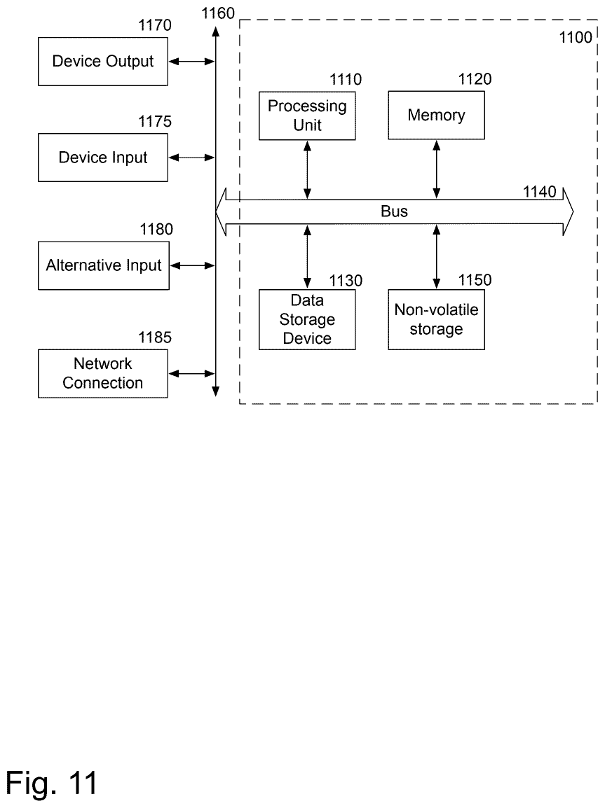

FIG. 11 is a block diagram of a particular machine that may be used with the present invention. It will be apparent to those of ordinary skill in the art, however that other alternative systems of various system architectures may also be used.

The computing system illustrated in FIG. 11 includes a bus or other internal communication means 1140 for communicating information, and a processing unit 1110 coupled to the bus 1140 for processing information. The processing unit 1110 may be a central processing unit (CPU), a digital signal processor (DSP), or another type of processing unit 1110. The system further includes, in one embodiment, a random access memory (RAM) or other volatile storage device 1120 (referred to as memory), coupled to bus 1140 for storing information and instructions to be executed by processor 1110. Main memory 1120 may also be used for storing temporary variables or other intermediate information during execution of instructions by processing unit 1110.

The system also comprises in one embodiment a read only memory (ROM) 1150 and/or static storage device 1150 coupled to bus 1140 for storing static information and instructions for processor 1110. In one embodiment the system also includes a data storage device 1130 such as a magnetic disk or optical disk and its corresponding disk drive, or Flash memory or other storage which is capable of storing data when no power is supplied to the system. Data storage device 1130 in one embodiment is coupled to bus 1140 for storing information and instructions.

The system may further be coupled to an output device 1170, such as a liquid crystal display (LCD) coupled to bus 1140 through bus 1160 for outputting information. The output device 1170 may be a visual output device, an audio output device, and/or tactile output device (e.g. vibrations, etc.)

An input device 1175 may be coupled to the bus 1160. The input device 1175 may be an alphanumeric input device, such as a keyboard including alphanumeric and other keys, for enabling a user to communicate information and command selections to processing unit 1110. An additional user input device 1180 may further be included. One such user input device 1180 is cursor control device 1180, such as a mouse, a trackpad, stylus, or touch screen, may be coupled to bus 1140 through bus 1160 for communicating direction information and command selections to processing unit 1110, and for controlling movement on display device 1170.

Another device, which may optionally be coupled to computer system 1100, is a network device 1185 for accessing other nodes of a distributed system via a network. The communication device 1185 may include any of a number of commercially available networking peripheral devices such as those used for coupling to an Ethernet, token ring, Internet, or wide area network, personal area network, wireless network or other method of accessing other devices. The communication device 1185 may further be a null-modem connection, or any other mechanism that provides connectivity between the computer system 1100 and the outside world.

Note that any or all of the components of this system illustrated in FIG. 11 and associated hardware may be used in various embodiments of the present invention.

It will be appreciated by those of ordinary skill in the art that the particular machine that embodies the present invention may be configured in various ways according to the particular implementation. The control logic or software implementing the present invention can be stored in main memory 1120, mass storage device 1130, or other storage medium locally or remotely accessible to processor 1110.

It will be apparent to those of ordinary skill in the art that the system, method, and process described herein can be implemented as software stored in main memory 1120 or read only memory 1150 and executed by processor 1110. This control logic or software may also be resident on an article of manufacture comprising a computer readable medium having computer readable program code embodied therein and being readable by the mass storage device 1130 and for causing the processor 1110 to operate in accordance with the methods and teachings herein.

The present invention may also be embodied in a special purpose appliance including a subset of the computer hardware components described above. For example, the appliance may include a processing unit 1110, a data storage device 1130, a bus 1140, and memory 1120, and no input/output mechanisms, or only rudimentary communications mechanisms, such as a small touchscreen that permits the user to communicate in a basic manner with the device. In general, the more special purpose the device is, the fewer of the elements need be present for the device to function. In some devices, communications with the user may be through a touch-based screen, or similar mechanism. In one embodiment, the device may not provide any direct input/output signals but may be configured and accessed through a website or other network-based connection through network device 1185.

It will be appreciated by those of ordinary skill in the art that any configuration of the particular machine implemented as the computer system may be used according to the particular implementation. The control logic or software implementing the present invention can be stored on any machine-readable medium locally or remotely accessible to processor 1110. A machine-readable medium includes any mechanism for storing information in a form readable by a machine (e.g. a computer). For example, a machine readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical or other forms of propagated signals (e.g. carrier waves, infrared signals, digital signals, etc.).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A method of providing a design for automated assembly (DFAA) system comprising:
receiving a model of a component and a part for insertion into the component;
identifying an assembly process for assembling the component and the part;
evaluating the component, the part, and the assembly process using a multi-phase evaluation including a geometric, a spatial, and a physics-based evaluation; and
outputting results of the evaluating, the results used to assess a design of one or more of the component, the part, and the assembly process.

2. The method of claim 1, further comprising:
wherein the spatial evaluation comprises:
identifying an insertion path for a part;
calculating a swept volume for the component and tool for automated insertion based on the insertion path; and
identifying clearance distances based on the swept volume.

3. The method of claim 2, further comprising:
providing a detailed report including minimum clearances along the insertion path output by the DFAA system.

4. The method of claim 3, further comprising:
using the minimum clearances and known tolerances of the components and assembly equipment to calculate a minimum/maximum tolerance match to identify the clearance distances.

5. The method of claim 4, wherein assembly includes one or more of: automated assembly and manual assembly.

6. The method of claim 1, further comprising:
performing a physics evaluation of an insertion process.

7. The method of claim 1, wherein performing the geometric evaluation comprising:
automatically analyzing the model to identify parts and topology and classify the component and the part; and
attaching classification data to the model.

8. The method of claim 7, further comprising:
converting the model to a unified format, prior to performing the geometric evaluation.

9. The method of claim 1, wherein the spatial evaluation calculates an insertion path, and wherein the insertion path takes into account the component, the part, an insertion tool, and an assembly state of the component.

10. The method of claim 1, further comprising:
providing a 3D visualization and analysis of results.

11. The method of claim 1, further comprising:
evaluating automatability of assembly of the component and the part, including data from failure mode and effects analysis (FMEA).

12. The method of claim 1, further comprising:
performing a digital twin simulation of an insertion process for the part, and for all parts;
wherein the digital twin simulation utilizes the spatial evaluation to take into account an assembly state of the component, including any previously inserted components.

13. The method of claim 12, further comprising:
utilizing an artificial intelligence (AI) system trained by analysis of assembly of a plurality of types of components to evaluate the model prior to the digital twin simulation.

14. The method of claim 13, further comprising:
classifying the model to identify one or more subparts of the component and locations for the part using the AI system.

15. The method of claim 14, further comprising:
identifying one or more features on the component, each of the features identified as one of: improving assembly accuracy and reducing assembly accuracy.

16. The method of claim 1, further comprising:
enabling iteration of a design of the model based on feedback from the DFAA system to improve designs and assess optimizations for design choices based on the results.

17. The method of claim 1, further comprising:
determining that a portion of an assembly process is a manual process, and for the manual process, evaluating spacing including finger clearance and operator fatigue based on combined mass of components assembled through the manual process.

18. The method of claim 1, further comprising:
identifying manual assembly errors and recommending features that reduce the manual assembly errors.

19. A method of providing a design for automated assembly (DFAA) system comprising:
receiving a model of a component and a part for insertion into the component;
performing a geometric evaluation to analyze the model and identify all subparts and topology and classify the component and the part;
performing a spatial evaluation to determine relationships between the component and the part and the subparts for assembly using an artificial intelligence system to analyze the model;
calculating an assembly process for assembling the component and the part, the assembly process including all subparts, the assembly process including one or both of automated assembly using a robotic system and manual assembly;
evaluating the component, the part, the subparts, and the assembly process using a multi-phase evaluation to determine whether the model can be assembled; and
providing feedback to trigger a re-design of one or more of the component and the part, based on the evaluating.

20. A design for automated assembly (DFAA) system comprising:
an end-user application to receive a design for analysis, the design for analysis comprising a component and one or more parts for assembly;
a visualizer to perform a geometric evaluation to analyze the design for analysis and identify all subparts and topology and classify the component and the part;
a DFAA analyzer to perform a spatial evaluation to determine insertion paths for each of the subparts and calculating a swept volume for the component and tool for attachment based on the insertion path and identifying clearance distances based on the swept volume, and to perform a physics evaluation to ensure sufficient clearances for assembly;
a DFAA validator to verify that the design for analysis can be assembled using the tool; and
a collaborate tool to provide feedback based on an output of the DFAA validator, to enable optimization of the design for analysis.
